(19) United States
(12) Patent Application Publication
(10) Pub. No.: US 2016/0179476 A1
(43) Pub. Date: Jun. 23, 2016

(54) Method Of Operating A Software Engine For Storing, Organizing And Reporting Data In An Organizational Environment Through User Created Templates And Data Items By Executing Computer-Executable Instructions Stored On A Non-Transitory Computer-Readable Medium

(71) Applicant: Samir Issa, Dubai (AE)

(72) Inventor: Samir Issa, Dubai (AE)

(21) Appl. No.: 14/987,753

(22) Filed: Jan. 4, 2016

Related U.S. Application Data
(63) Continuation-in-part of application No. 13/613,233, filed on Sep. 13, 2012, now abandoned.

(51) Int. Cl. G06F 9/44

(52) U.S. Cl. CPC G06F 8/315; G06F 8/34

(57) ABSTRACT

In a method of operating a software engine for storing, organizing and reporting data in an organizational environment through user created templates and data items, users can build highly customizable templates for data and web forms for data entry, with many different specifiable attributes. Related data is linked and can be queried for retrieval. Users can design, create, add, and use unlimited number of forms, reports, business processes, and queries without any add-on programming.

The current application is a continuation-in-part (OP) application of the U.S. non-provisional application Ser. No. 13/613,233 filed on Sep. 13, 2012. The U.S. non-provisional application Ser. No. 13/613,233 is pending until Jan. 2, 2016. The current application is filed on Jan. 4, 2016, whereas Jan. 2, 2016 and Jan. 3, 2016 were on a weekend.

### FIELD OF THE INVENTION

The present invention relates generally to data organization. More particularly, the present invention relates to a software engine and method for organizing data in a business domain.

### BACKGROUND OF THE INVENTION

In all business domains and transactions, capture of data is done through electronic forms that customarily store data in tables related to forms. A form in that sense, is more or less, a window of the End User to the database table. Usually the tables are designed by mapping business transactions to software objects in what is known as object oriented programming (OOP).

To build an object oriented program, there is a prolonged phase of analysis of the business domain and business transactions, by an expert information engineer, to optimize the architecture to meet End User requirements.

GUI designers strive to meet multi End User needs of access to multiple forms representing business objects, and try to do this in the least possible number of GUI instances i.e. forms/menus/buttons. However, when business objects are numerous due to specific and detailed requirements of the business, this often leads to many forms/menus with visually overloaded designs. As a result, complicated GUI requires significant training and long usage before achieving a satisfactory return on time investment of both the End User and the organization.

Furthermore, if End User requirements change for any reason, adopting that change requires always analysis of the new requirements, integration with the changes with previous design, and certainly significant code writing and back-end changes in the database. Often times, such changes are hard to obtain because they have a significant financial and logistic overhead. End Users usually try to live with the shortcomings of the software even though this would impact productivity.

An Object Oriented Program targets a specific business domain with specific End User needs. In a multidisciplinary enterprise, different End User requirements lead to the creation of multiple applications; however, enterprises need certainly includes queries that span information acquired in more than one application; and interconnecting those applications to meet those needs resulted in the creation of what is known as ERP systems—Enterprise Resource Planning applications—ERP systems transact with a single database serving several applications with many tables. ERP programs are out of the reach of small to medium sized enterprises, entail significant initial programming, and exhausting End User training. Even so, any change of End User requirements means significant programming and integration overhead.

There is still room for improvement in the art. Therefore, it is the object of the present invention to provide a software engine that enables end users to design, create and use an unlimited number of different types of forms, reports, and queries over a computer network.

### BRIEF DESCRIPTION OF THE DRAWINGS

FIG. 1a is a stepwise flow diagram showing the general process of the present invention.

FIG. 1b is a stepwise flow diagram continued, showing the general process of the present invention.

FIG. 2 is a stepwise flow diagram showing steps for using the web controls and processing a data report request.

FIG. 3 is a stepwise flow diagram showing steps for processing ditems against business rules.

FIG. 4 is a stepwise flow diagram showing steps for processing mobjects against business rules.

FIG. 5 is a stepwise flow diagram showing steps for processing end user permissions.

FIG. 6 is a stepwise flow diagram showing steps for using the render module.

FIG. 7 is a stepwise flow diagram showing steps for using the submitter module.

FIG. 8 is a stepwise flow diagram showing steps for using the central module.

FIG. 9 is a stepwise flow diagram showing steps for using the reader module.

FIG. 10 is a stepwise flow diagram showing steps for performing a parallel insertion.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a data value-centered programming method and software engine for the storing, organizing and reporting data in an organizational environment through user created templates and data items that enables end users to design, create and use an unlimited number of different types of forms, reports, and queries over a computer network.

In this document, the term “end user” refers to a computer user who does not have any programming or coding knowledge. The term “environment” refers to the computer state-definition of the organization that is making use of the invention. The term “business domain” refers to any of the different business domains that uses software to record business transaction. Examples of business domains include, but are not limited to: health services provision, student education, customer relations management, and vehicle manufacturing. A “software application” or “application” is a compiled code that executes specific functions built to meet specific end user requirements and is immediately available, without further coding required from end users. A “software engine” or “engine” is a compiled code that executes generic computer functions that are built to meet generic end user or environment requirements, and is immediately available, without further coding required from end users. A “programming method” or “programming application” is a software application that helps software programmers to design and encode a software application.

The present invention relates to a software engine that employs several software modules that enable an environment's end user to design, create, and use an unlimited number of different types of forms, reports, and queries over a network or the web. The present invention is claimed hereinafter as a method of operating the software engine, but is additionally disclosed and described herein as a software engine in its implementation. The method steps claimed do not necessarily directly reflect any specific coding or other implementation details of the present invention, rather the general logical process of facilitating the operation of the software engine.

In a general overview of the present invention, a template builder module or application allows an end user to build computer-readable templates within a digital environment for any desired purpose. The templates are extremely versatile and may be built with any number or structure of data inputs, web controls, rules, user restrictions, executable instructions, or other attributes. Once built, a template is stored in a template database, from which it can be retrieved for use. An end user may retrieve the template by requesting it through a graphical user interface (GUI). The template is rendered as a web form on the GUI, and the end user inputs values and otherwise interacts with the web form. The web form receives runtime data when the end user saves or submits the web form, and the newly acquired data is bundled and stored in a production database.

Data is related in the production database in numerous ways, and the database can be queried to show an end user desired data ranges and/or relations.

The special features that make the present invention stand out compared to existing art are that the present invention can be implemented in any organization of any size, type, and field of activity without any additional programming. Users can design, create, add, and use unlimited number of forms, reports, business processes, and queries without any add-on programming. No back-end database changes are required to accommodate front-end changes such as adding or changing forms, reports, business processes, or queries.

Each of the steps in the method of the present invention carries an engine-specific transformation in the state of data from its occurrence to retrieval; the uniqueness of the present invention invention is that transformations are independent of any changes in data nature, structure, or format at both the occurrence-capture end and the storage-retrieval end. This independency eliminates the need of programming in order to accommodate business requirements or rules changes.

The environment of the present invention is defined in order to make the software engine of the present invention meaningful by operating within a business environment. A digital environment, or business environment, or simply environment, generally will refer to the computer state-definition of a singular organization or business making use of the present invention. Within the environment, entities can be defined. Entities can be, but are not limited to, persons, devices, places, or groups. Each person in an environment is an entity but can be associated with several roles. For example a person in a doctor role may also be in a patient role, a chairman role, or another role. Instances of roles can be linked to each other in the production database. A given entity A with the role of patient will be linked in the environment with another entity B with the role of doctor, where B is the doctor in charge of patient A. A self-reflecting relation table is utilized between role instances.

In the preferred embodiment of the present invention, the production database has a fixed table-definition that does not change regardless of the number of feeding forms or executed reports/queries. The Production Database can be implemented by any industrial-strength database engine. The production database has as a fixed table-definition of four tables.

A mobject table of the production database stores the state of set of attributes of mobjects reflecting end user input and runtime processing.

A ditem template table stores the definition of all used ditem templates.

A ditem table stores the state of the set of attributes of ditems reflecting end user input and runtime processing.

A mobject link table stores relations between instances of stored mobjects. This table is update during runtime processing according to a set of rules that define a certain state of Mobject sequence during runtime.

Each of these tables can be interrogated individually or collectively as part of a joint query between Mobject-Ditem tables.

The template database stores the templates of web controls and web forms that are composed by the template building module. The template database can be interrogated by the central module to retrieve templates and process them to retrieve reports, queries, or provide them for consumption to the render module to display them as web forms

There are two types of templates in the present invention: data item (ditem) templates, and metadata object (mobject) templates. Ditem templates and mobject templates refer to the initial state of a template before being updated with end user values and runtime values. The terms ditem and mobject, on the other hand, refer to templates already saved in the production database and containing end user input or runtime values.

A ditem is essentially a piece of data with other attributes. Ditems templates acquire a value and are born as ditems in the context of a transaction. A transaction is the process of retrieving a template from the template database, filling it, and submitting it to the production database. Ditems may have include several types of attributes: descriptive attributes, which are used to specify the ditem's datatype, its name, its display name, its creation date, or to qualify its numeric values. Ditems may have relational attributes, such as unique code or a related mobject identifier. Ditems may also have GUI and display related attributes, such as shape and display in various language, among other display attributes. Ditems may have attributes related to validation of the value, such as, but not limited to, value data type, and limitations on the value. Ditems may have attributes related to the source of a value: if it's a direct end user input, an externally fetched value, a calculated value, or from a provided drop-list, or elsewhere. Ditems may have processing attributes, such as, but not limited to, date/time of value edit, if the ditem has been consumed or not, its order on a web form, its state of imperativeness on the container web form, and so on. Further ditem attributes are described further on herein.

In a transaction example: ‘Drawing blood for a complete blood count laboratory test’—itself has a set of attribute values that together identify the context of occurrence of the born item(s). For example: ‘Volume of Blood’ cannot in this context be of integer value of 100. Continuing with the example, in hospital H, nurse N withdraws 5 milliliter of blood from patient P at 3 PM on 1 January for a complete blood analysis ordered by Doctor D. When this transaction happens some information is new indicating the birth of a one or more, i.e. a set of data item(s) under a repeatable one context of occurrence. The context is: Withdrawal of blood in hospital H by a licensed laboratory nurse from a patient based on a licensed doctor D request.

The set of born data items are:
Nurse ID=N
Patient ID=P
Volume of withdrawn blood=5 with the descriptive qualifier milliliter
Test to be done: Complete Blood Count
Date/Time of occurrence: 3 PM on 1 January
Requesting Doctor=D

This example demonstrates the functionality of the present invention in storing and organizing data. The data items are stored in the production database and associated with each other and with the context. The production database can then be queried in the future for other information related to the above transaction; for example, querying the production database for other transactions in which nurse N, patient P, or doctor D were involved, or for blood withdrawals within a specified date range.

Mobject templates are templates of forms used to submit and store data. Mobjects are mobject templates that have been filled with user input values and runtime data. Mobjects have unfilled ditems, which are user defined through the template builder.

The present invention is preferably embodied and implemented by using web forms on a computer network. An end user, such as a nurse, accountant or teacher, depending on the business environment, will access the present invention through a computer by accessing a network address, such as a web site on the internet or a web page on a server associated with the business. The present invention may be programmed in any relevant and useful programming language, such as, but not limited to, HTML, PHP, Perl, Java, JavaScript, XML, JSON, C++, Python, Ruby, or any other programming language that can feasibly be utilized to facilitate the present invention.

The user interface in the preferred embodiment of the present invention is composed of dynamically rendered web pages and web forms comprising web controls such as text boxes, drop-down menus, buttons, and other web controls. The real world implementation of this method requires no programming or code writing; therefore, the end user can use it as a generic Enterprise Resource Planning software that has a minimal financial and logistic overhead.

The present invention concentrates on capturing end user input for a certain data item value by a specific web control. The control is fully described in a computer-readable text in the data item template. End user input for a set of data items born under the same context is captured in a single web form. The template that describes this web form has several attributes, some of which are assigned definite values when the template is designed, and other attributes that will get their values when the web form is executed during runtime. The captured values are saved to the database.

The present invention generally depends on the production database, the template database, and five basic software modules. The software modules function together to capture, store, and retrieve data in any business domain regardless of the nature of the business or its transactional rules.

The first software module is a template builder module. The template builder module is a standalone application with a wizard GUI that leads an end user through a process to create computer-readable templates composed of XML and/or JSON markup. The End user of writes no code and builds the templates simply by following the wizard flow.

Templates built in the template builder can be of several types:
Data items templates, or ditem templates, serve to hold a single, strongly typed, data value with its validation rules.
Web form templates group several templates of ditem type. A web form template itself has a set of attributes whose values describe the state of occurrence of ditem values, which is meta data of ditems enriched with end user input and processing generated runtime values.
Web report templates retrieve one or more formatted pieces of information from the production database, such as, but not limited to, ditems.
Query templates retrieve the results of a query that resides in the template.
Business process templates define a certain mix of web forms accessed either with or without an imperative sequence.

The second software module is referred to as the central module. The central module acts to send and receive the computer readable templates between the other modules. The central module does not perform any processing on the templates; however, the central module creates runtime values that reference organizational entities performing business transactions, and pass those values to the other modules for updating templates' related attributes.

The third software module is referred to as a render module. The render module: receives computer-readable templates, processes them, and displays web forms rich with web controls; captures end user input in web controls of the web form, and validates the values according to the web control and web form template validation rules; and submits the templates after updating them with end user input to be saved, upon end user submittal action.

A render occurs either when a mobject is newly created from a specific mobject template, or when a mobject is retrieved for review from the production database.

The fourth software module is referred to as a submitter module. The submitter module receives the templates updated by end user input and saves the content of values in the production database.

The fifth software module is referred to as a reader module. The reader module receives and processes different types and numbers of query and report templates and executes them against the production database. Query and report results are returned as computer-readable files that can be processed by the render module or by the central module.

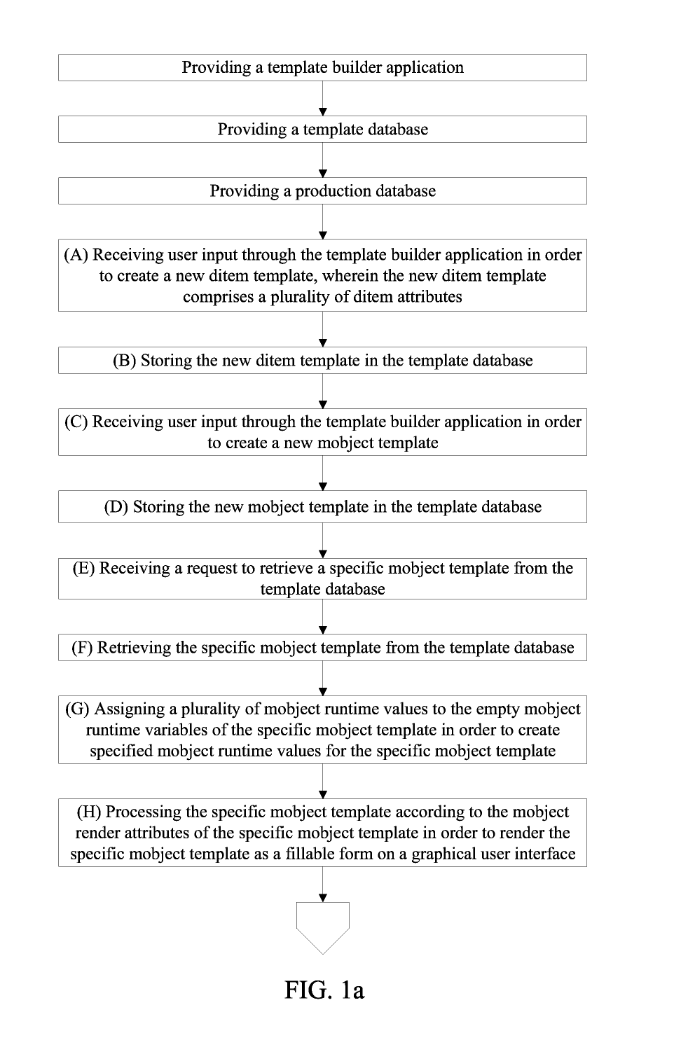

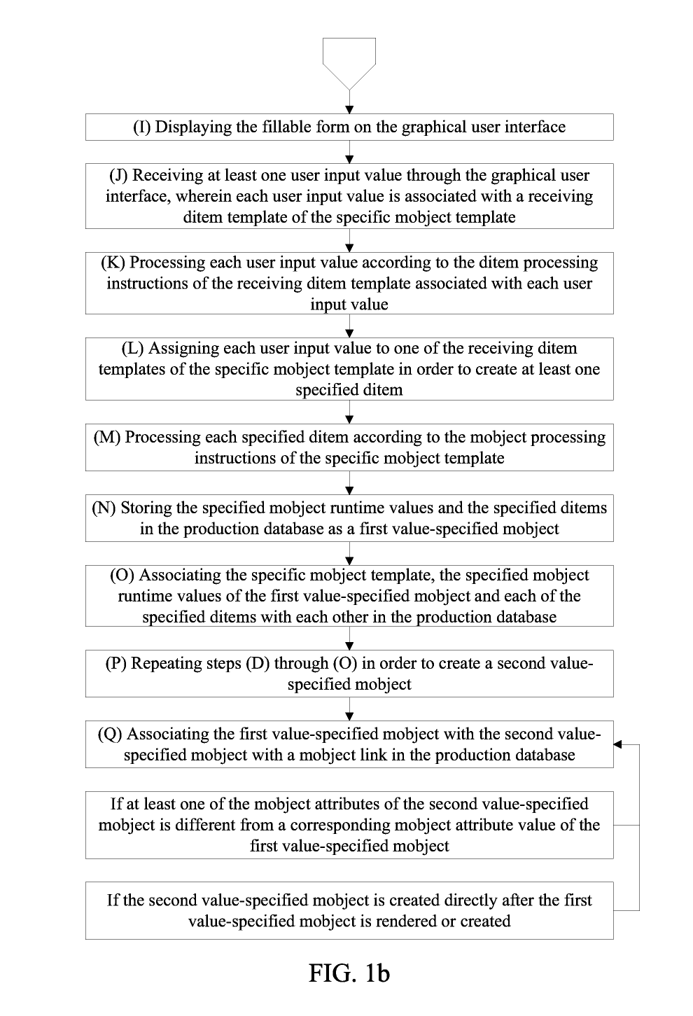

Referring to FIG. 1, in the method of operation of the software engine of the present invention, a template builder application is provided, as well as a template database and a production database. User input is received through the template builder application in order to create a new data item (ditem) template (A). The new ditem template comprises a plurality of user-assigned variables, a plurality of empty ditem runtime variables, a plurality of ditem processing instructions, and a plurality of ditem render attributes. The new ditem template is stored in the template database (B).

User input is then received through the template builder application in order to create a new metadata object (mobject) template (C). The new mobject template comprises at least one ditem template, a plurality of empty mobject runtime variables, a plurality of mobject processing instructions, a plurality of mobject attributes, and a plurality of mobject render attributes. The new mobject template is stored in the template database (D).

Subsequently, a request to retrieve a specific mobject template from the database is received (E), and the specific mobject template is retrieved from the template database (F). Then, a plurality of mobject runtime variables are assigned to the empty mobject runtime variables of the specific mobject template in order to create specified mobject runtime values for the specific mobject template (G). The specific mobject template is processed according to the mobject render attributes of the specific mobject template in order to render the specific mobject template as a fillable form on a graphical user interface (H).

The fillable form is then displayed on the graphical user interface (I). At least one user input value is received through the graphical user interface, wherein each user input value is associated with a receiving ditem template of the specific mobject template (J). The fillable form comprises a plurality of web controls, or a single web control, and the user input values are received through the plurality of web controls. Each input value is processed according to the ditem processing instructions of the receiving ditem template associated with each user input value (K). Each user input value is assigned to one of the receiving ditem templates of the specific mobject template in order to create at least one specified ditem (L). Each specified ditem is processed according to the mobject processing instructions of the specific mobject template (M). The specified runtime values and the specified ditems are stored in the production database as a value-specified mobject (N), alternatively referred to herein as a first value-specified mobject for later reference. The production database may hold many value-specified mobjects. The specific mobject template, the specified mobject runtime values of the first value-specified mobject and each of the specified ditems are associated with each other in the production database (O).

A second value-specified mobject is then created (P) by repeating steps (D) through (O). The first value-specified mobject is then associated with the second value-specified mobject with a mobject link in the production database (Q) if at least one of the mobject attributes of the second value-specified mobject is different from a corresponding mobject attribute value of the first value-specified mobject, and if the second value specified mobject is created directly after the first value-specified mobject is either created or rendered.

A mobject link is created between two mobjects only when the following two conditions are met: (1) Value of a certain attribute X in mobject 2 is different from its value in mobject 1, and (2) Mobject 2 is created immediately, in the same session, following closing of a rendered—by retrieval, or creation—of mobject 1. A given mobject is linked with the next newly created mobject, if attribute X value has changed between the two mobjects. Linking of mobjects is only by creation or render sequence when value of attribute x changes between two sequential mobjects and the second mobject is being newly created. There is no other relation between linked mobjects, and mobject links create an association between, otherwise, unrelated mobjects. In other words, the attribute used to link two mobjects is a grouping attribute, and is defined by the end user who made the mobject template. Examples of mobject grouping attributes include, but are not limited to: Username, set in runtime; USER Workgroup, set in runtime; Mobject Class, set in template builder; Application Name, set in template builder.

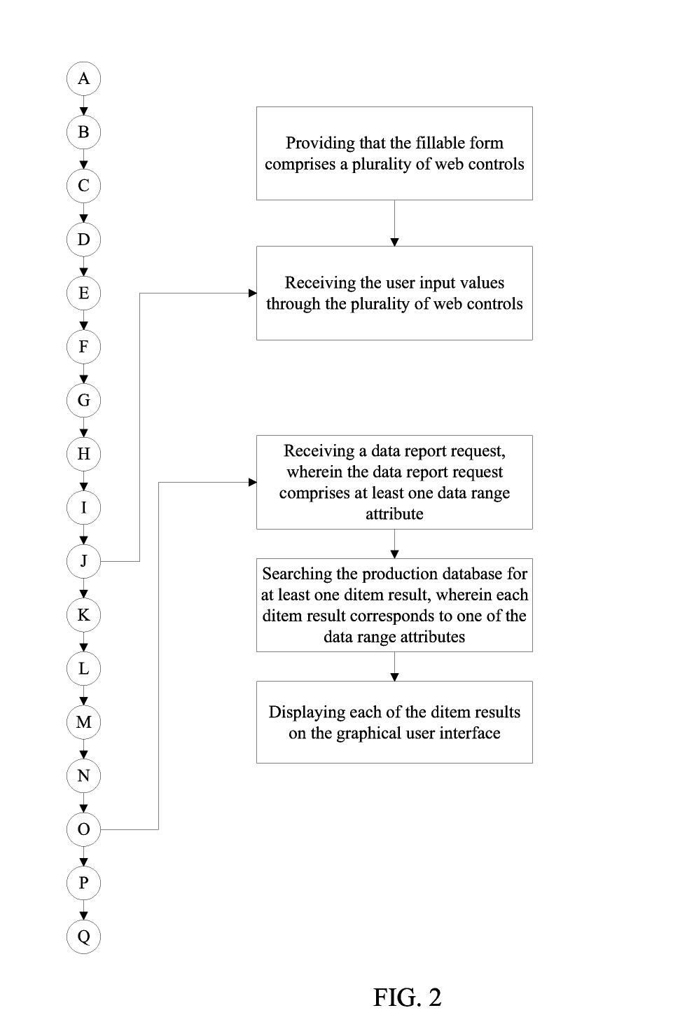

After value-specified mobjects are stored in the production database, the associated data can be retrieved for report. To this end, as shown in FIG. 2, an end user can submit a data report request, which is received by the system. The data report request comprises at least one data range attribute. The production database is searched for at least one ditem result, wherein each ditem result corresponds to one of the data range attributes. If the ditem results are found, each of the ditem results are displayed on the graphical user interface.

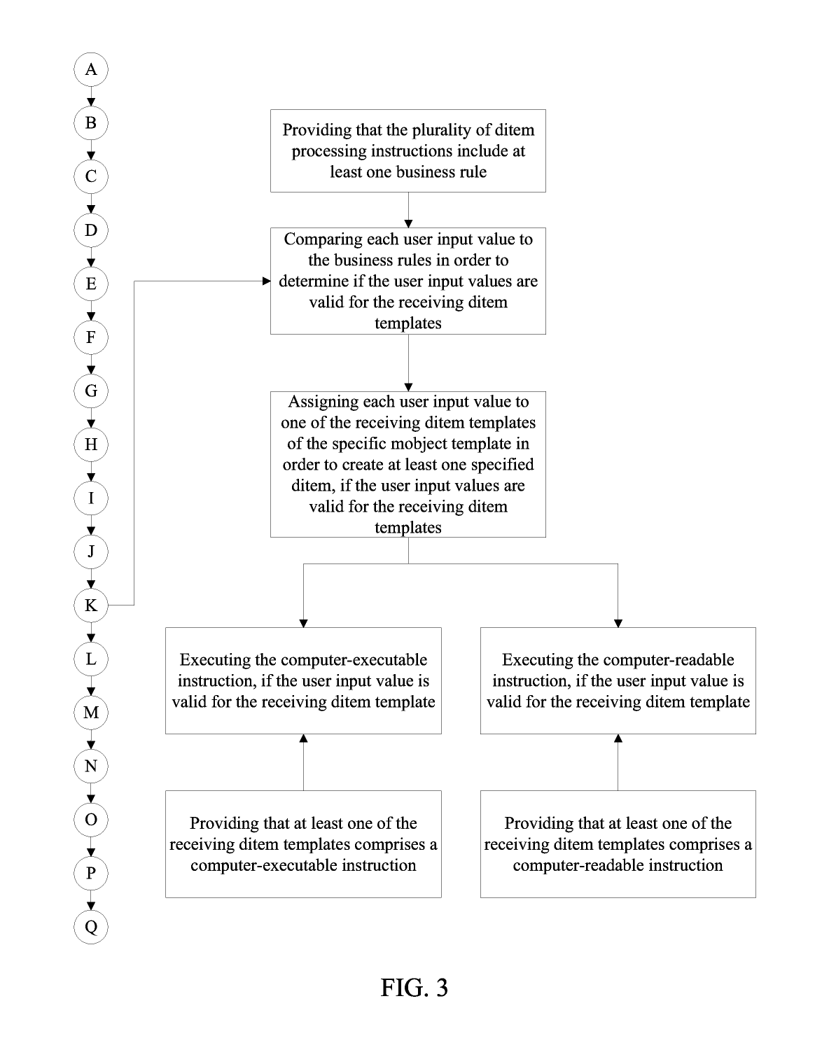

Referring to FIG. 3, the plurality of ditem processing instructions may include at least one business rule. The nature of business rules may vary between business environments. Business rules are defined by the end user who creates the ditem template or mobject template. An example of a business rule may be that a certain ditem value may not exceed a specified quantity. When the ditems are processed, each user input value is compared to the business rules in order to determine if the user input values are valid for the receiving ditem templates. If the user input values are determined to be valid for the receiving ditem templates, each user input value is assigned to one of the receiving ditem templates of the specific mobject templates in order to create at least one specified ditem.

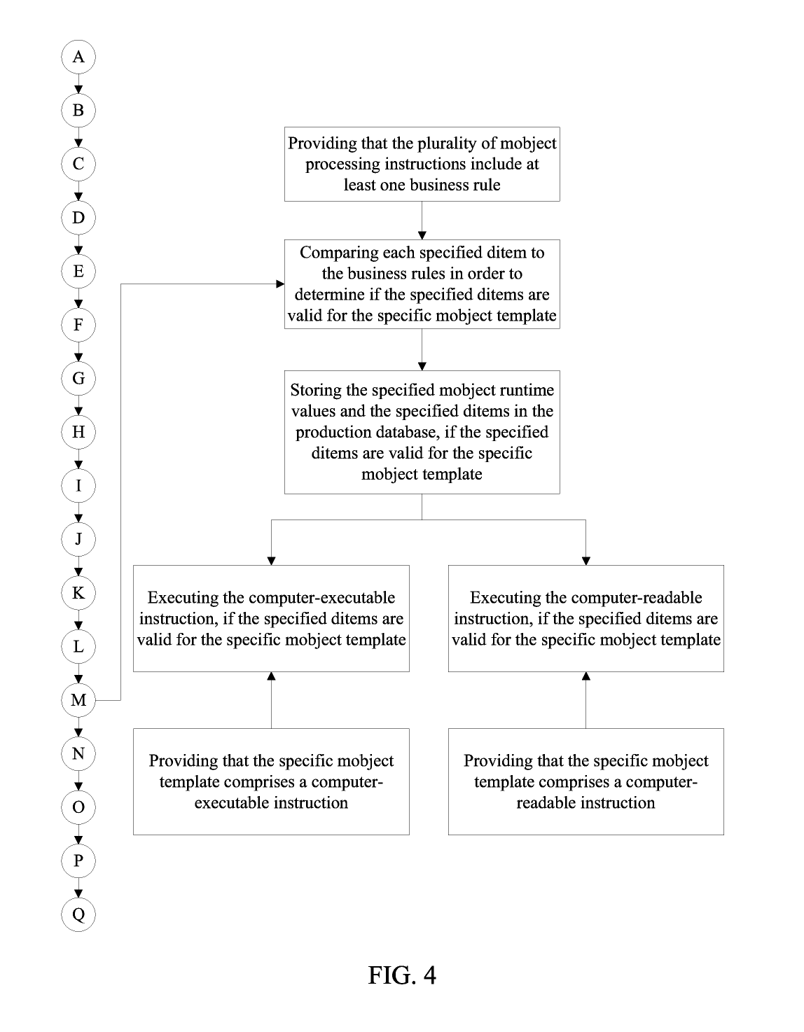

Similarly, referring to FIG. 4, if the plurality of mobject processing instructions include at least one business rule, each specified ditem is compared to the business rules in order to determine if the specified ditems are valid for the specific mobject template. If the specified ditems are determined to be valid for the specific mobject template, the specified mobject runtime values and the specified ditems are stored in the production database. Additionally, if the specific mobject template comprises a computer-executable instruction or a computer-readable instruction, the computer-executable instruction or computer-readable instruction is executed if the specified ditems are valid for the specific mobject template.

The receiving ditem templates may additionally comprise computer-executable or computer-readable instructions. If at least one of the receiving ditem templates comprises a computer-executable instruction or a computer-readable instruction, the computer-executable instruction or the computer-readable instruction is executed, if the user input value is valid for the receiving ditem templates.

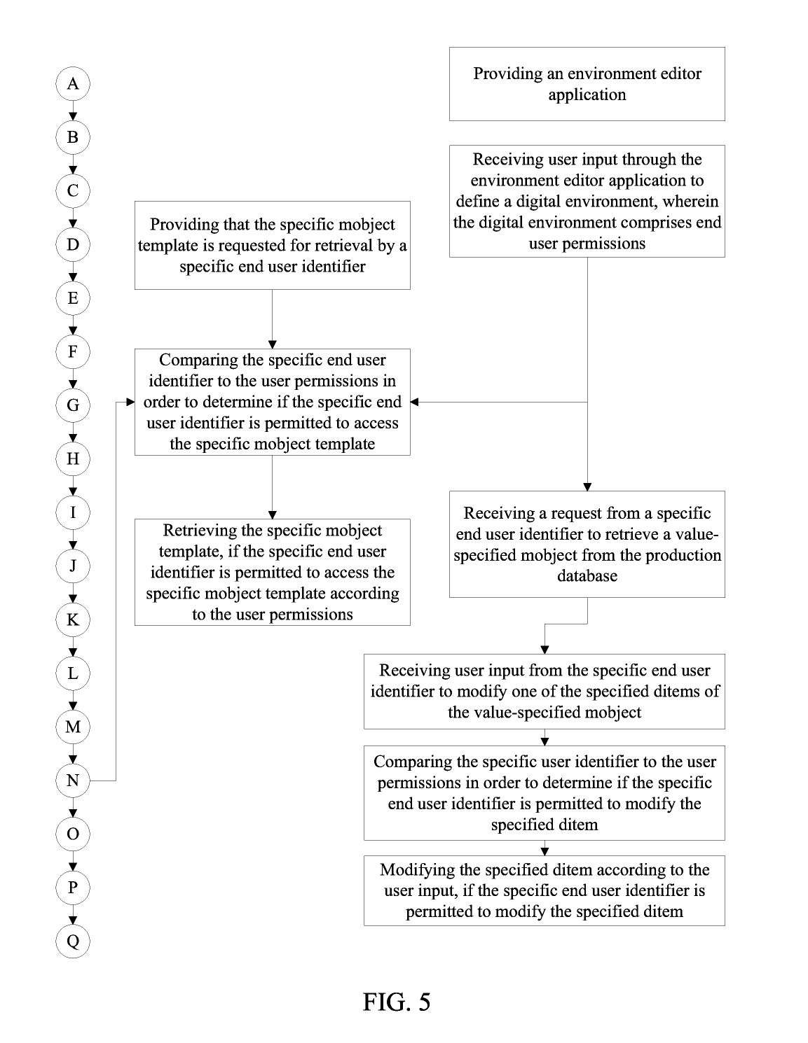

Referring to FIG. 5, an environment editor application is also provided in the preferred embodiment of the present invention. User input is received through the environment editor application in order to define a digital environment, wherein the digital environment comprises end user permissions. The environment editor application will typically be utilized by an administrator to initialize or edit the digital environment.

The end user permissions can be used to restrict access to various components of the present invention. For example, a specific mobject template or ditem type in a hospital environment may be specified to only be allowable to access or modify by doctors and surgeons, but not nurses. Providing that the specific mobject template is requested for retrieval by a specific end user identifier, the specific end user identifier is compared to the user permission in order to determine if the specific end user identifier is permitted to access the specific mobject template. The specific mobject template is retrieved if the specific end user identifier is determined to be permitted to access the specific mobject template according to the user permissions.

Furthermore, if a request is received from a specific end user identifier to retrieve a value-specified mobject from the production database, and if user input is received from the specific end user identifier to modify one of the specified ditems of the value-specified mobject, the specific user identifier is compared to the user permissions in order to determine if the specific end user identifier is permitted to modify the specified ditem. If the specific end user identifier is permitted to modify the specified ditem according to the user permissions, the specified ditem is modified according to the user input.

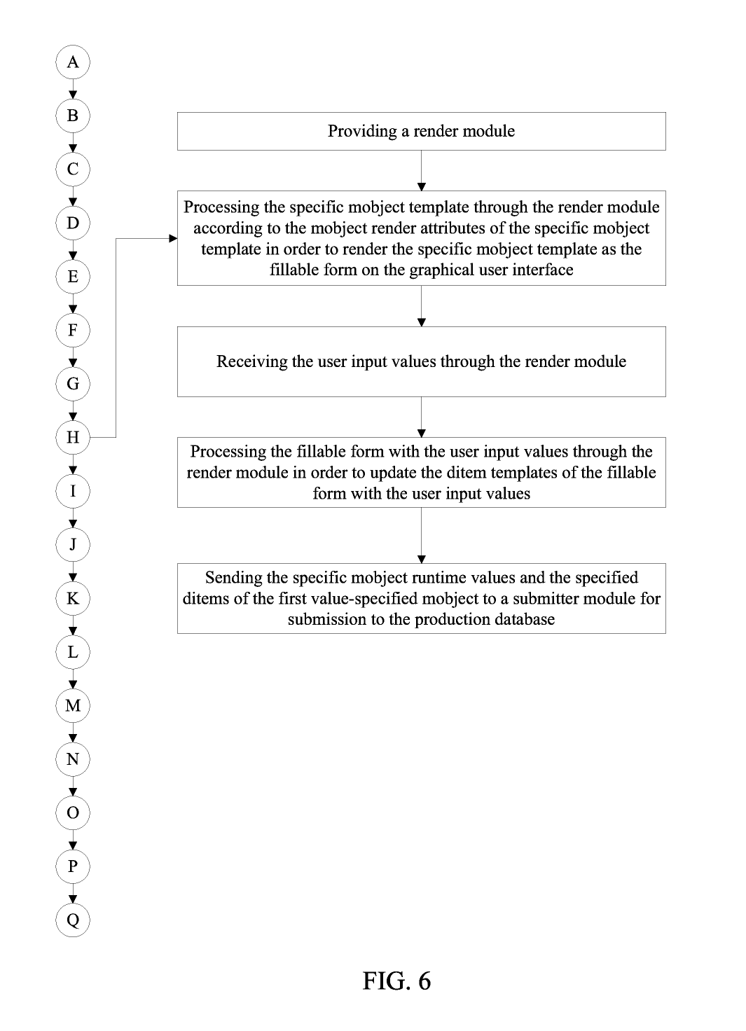

Referring to FIG. 6, in the preferred embodiment of the present invention, a render module is further provided as a software module of the software engine. The specific mobject template is processed through the render module according to the mobject render attributes of the specific mobject template in order to render the specific mobject template as the fillable form on the graphical user interface. The user input values are also received through the render module, and the fillable form is processed with the user input values through the render module in order to update the ditem templates of the fillable form with the user input values on the graphical user interface while the end user is entering the user input values. The specific mobject runtime values and the specified ditems of the first value-specified mobject are then sent by the render module to a submitter module, to be disclosed hereinafter, for submission to the production database.

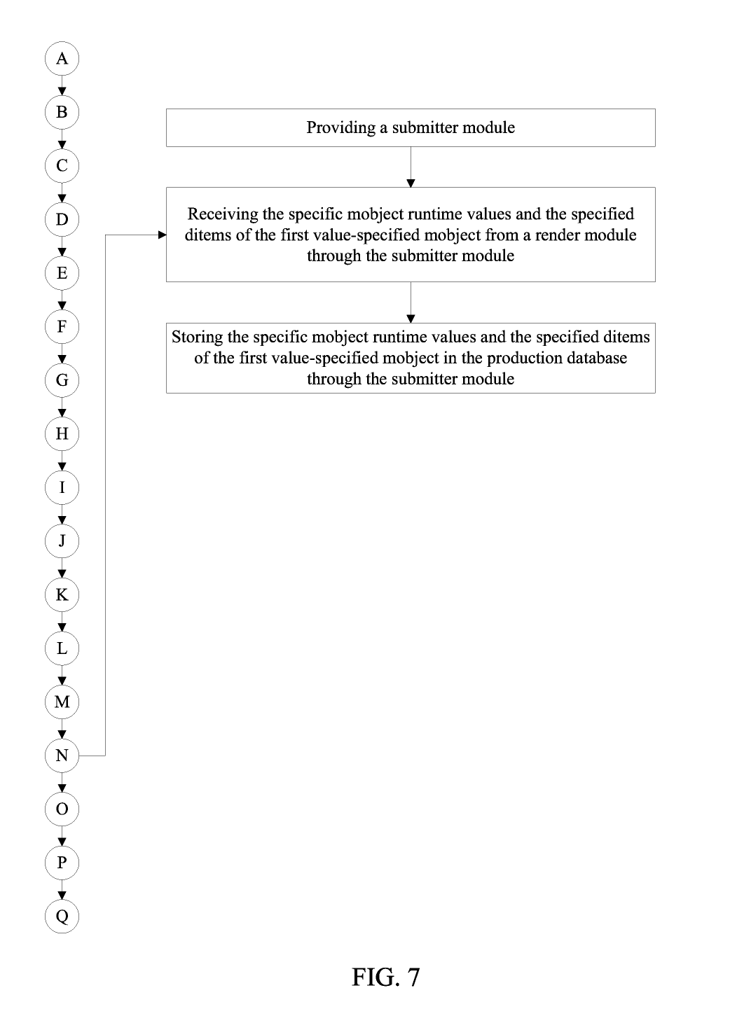

Referring to FIG. 7, in the preferred embodiment of the present invention, a submitter module is further provided as a software module of the software engine. The specific mobject runtime values and the specified ditems of the first value-specified mobject are received through the submitter module from the render module. The specific mobject runtime values and the specified ditems of the first value-specified mobject are then stored in the production database through the submitter module.

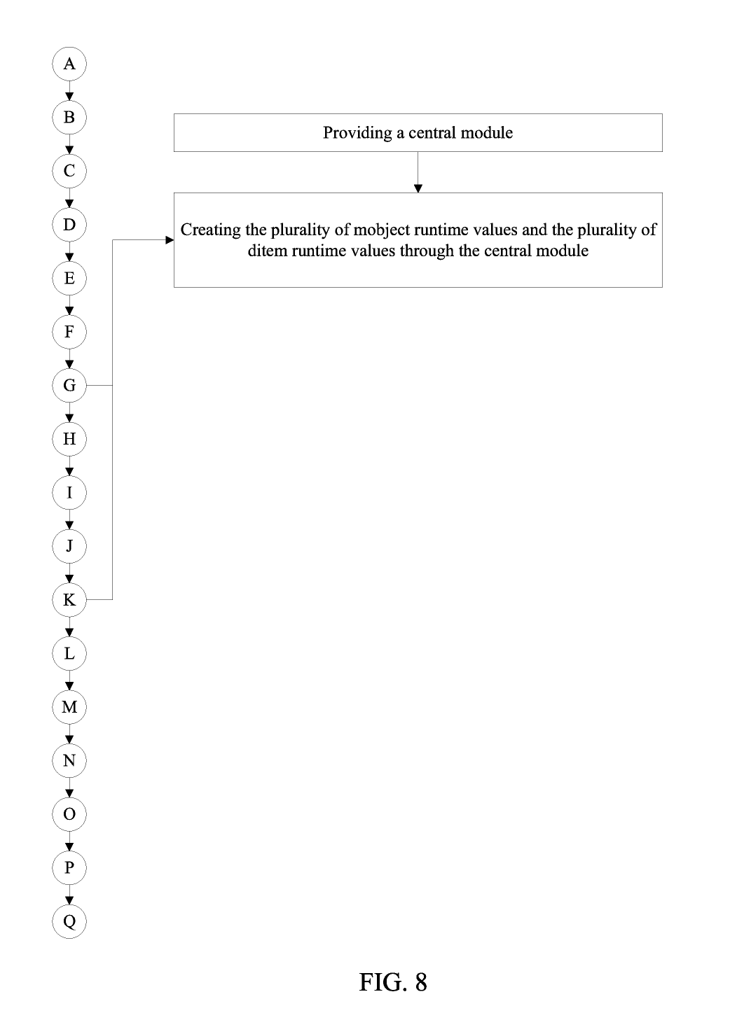

Referring to FIG. 8, in the preferred embodiment of the present invention, a central module is further provided as a software module of the software engine. The plurality of mobject runtime values and the plurality of ditem runtime values are created through the central module. The central module also handles communication between the render module, the reader module, the submitter module, the template database and the production database.

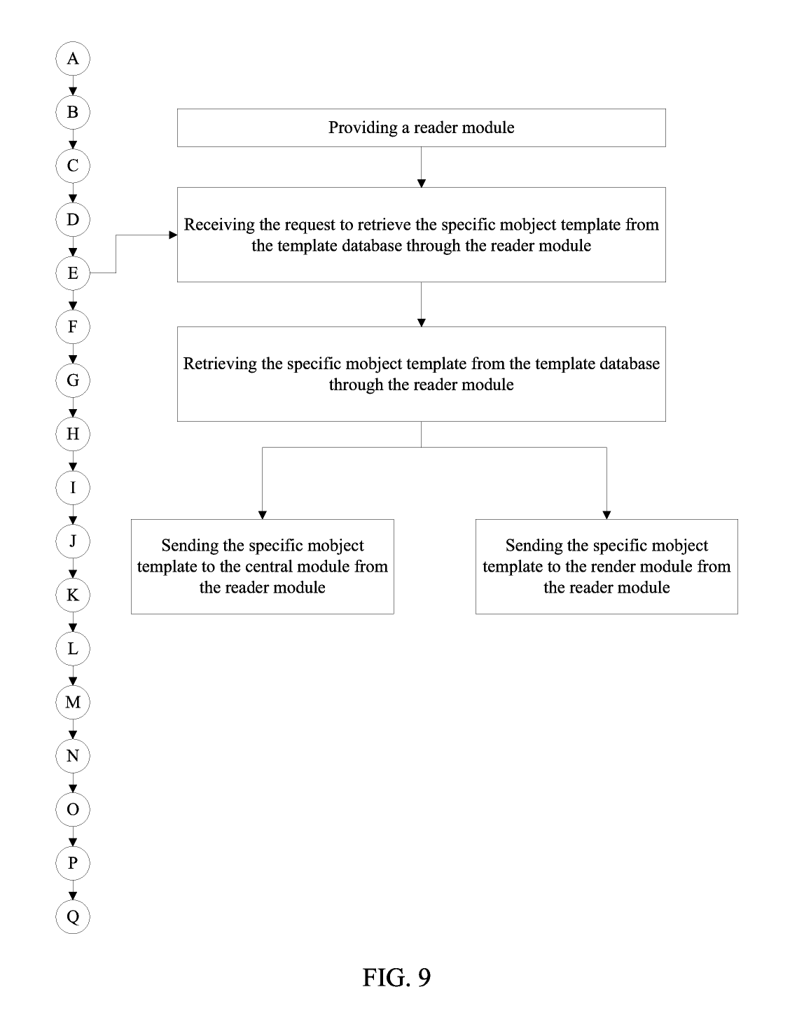

Referring to FIG. 9, in the preferred embodiment of the present invention, a reader module is further provided as a software module of the software engine. The request to retrieve the specific mobject template from the template database is received through the reader module, and the specific mobject template is retrieved from the template database through the reader module. Furthermore, the specific mobject template is sent either to the render module or to the central module from the reader module.

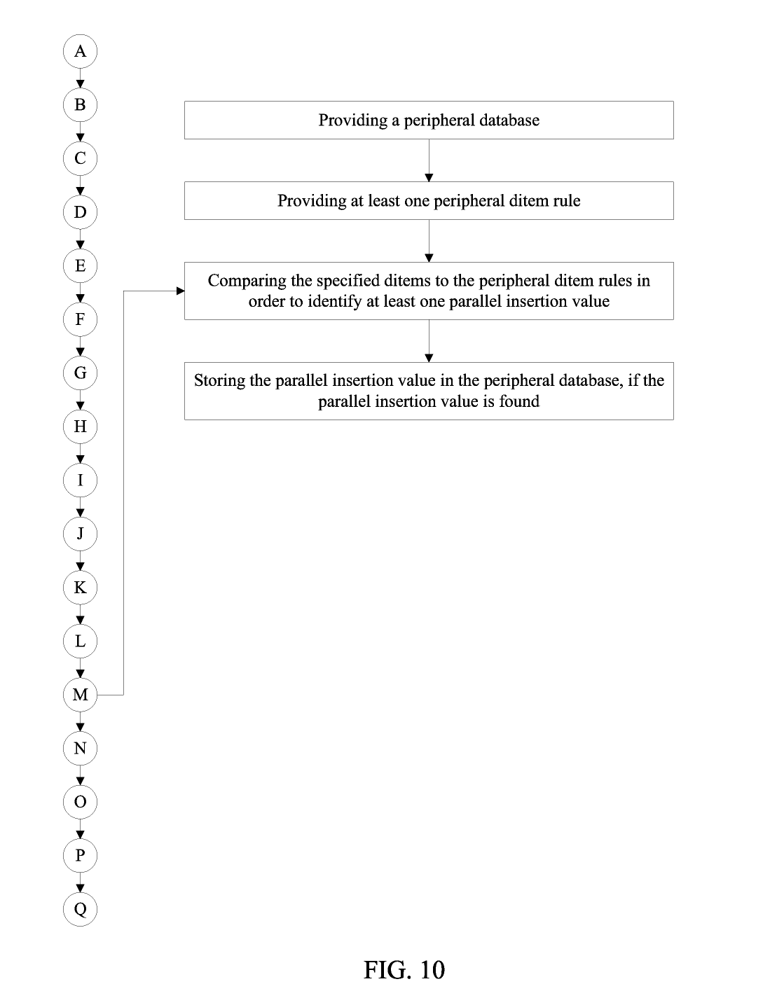

Referring to FIG. 10, the present invention further comprises a peripheral database, and at least one peripheral ditem rule. The specified ditems are compared to the peripheral ditem rules in order to identify at least one parallel insertion value. If the parallel insertion value is found, the parallel insertion value is stored in the peripheral database.

The further functional structure of ditems in the preferred embodiment of the present invention is as follows. Ditem templates inherit a basic set of attributes from an abstract base class; thus, all ditem types have common attributes, while certain attributes are not inherited and are specific to certain child classes according to the data type of the class; for example, a value qualifier attribute exists only for numeric data type ditems.

All ditem templates have a ‘Value’ attribute that is updated by the end user or runtime processing input. The ‘Value’ attribute can also be set at template design time to be used as a seed-value in the web form later when the control is executed on a web form.

All Ditem templates have a ‘Label’ attribute that represents the contextual name of the ‘Value’ in the business domain. In the Blood Sample Example below, the string ‘Volume of the withdrawn blood’ is the ‘Label’ of the ‘Value’ 5.

The ditem has a set of attributes that are descriptive and restrictive of the value of the item. For example, ‘Volume of Blood’ is measured by milliliters or liters depending on the context but it cannot be Boolean datatype, measured in kilometers, or be larger than a certain integer value.

Ditems may further have an ‘Annotation’ attribute that let the end user tag the Value with a string that further describes it. Example: A Potassium level of 8 in the blood chemistry profile can hold an annotation stating the blood sample was hemolyzed when received by lab. In this way, even purely numeric values can gain string descriptions that render them very reflective of the state of occurrence of the Value of Ditem.

Upon displaying a Ditem as a web control in a web form, the value entered by the end user in the control is assigned to the ‘Value’ attribute of the Ditem after validating it according to the set of validating attributes in the Ditem template.

In certain web controls, template processing assigns the ‘Value’ of the Ditem not from end user input, but from special processing instructed by the template. In that way, the ditems are aware of their own source of data and can display therefore to the end user a template-defined list of values either as a drop list, or, if the data source is a query SQL statement, guide the end user to select a value from a template-defined resource available over the network/internet exposes to the template a pre-designated web service.

Certain web controls are not visible to the end user on the web form in spite of the fact that they exist, with their ‘Value’ attribute already assigned a value when the template was designed. Certain web controls are visible to the end user on the web form but are disabled to become inaccessible for runtime editing. If the end user right-clicks any ditem web control on any web form displayed by the render module. An annotation form opens up permitting the end user to enter an annotation string. This string becomes assigned to the ‘Annotation’ attribute of the ditem in the template.

The functional structure of web form templates in the preferred embodiment of the present invention is as follows. Web form templates have two parts: a set of attached ditem templates, and a set of attributes pertaining to the web form itself.

The web form attribute set constitutes the definition of state of occurrence of the values of the ditem set.

The web form attribute set contains several groups of attributes whose values are assigned when the template is constructed. These values do or do not change during runtime processing of the template.

Any attribute could serve more than one objective, some are destined to control GUI features or menus, while others indicate runtime-generated events such as end user name, date-time, or the organization entity to which the template refers. The metadata attribute set serves finally as filtration parameters when the mobject table is queried in the production database.

Each web form template specifies whether the form can be filled and saved in several sessions; that is, if the form can be saved and then re-edited; or, if it has to be saved once without future editing. The web forms that are so-defined are protected with a specific end user pin that locks the web form according to template instructions when end user is saving the web forms. For example: workgroup, menu, and end user privileges.

Access to web forms templates and mobjects is regulated in the central module by certain business rules that relate attribute values of mobject to environment variables.

Web form templates can be displayed as web forms of several GUI types:
Classical stack-type of textboxes of classical forms
Invoice-Type where additional rows can be added
Comparison-Type where additional columns can be added
Multiple Horizontal Arrays of a Ditem,
Multiple Vertical Ditem Array
Composite type that is displayed on multiple tabs each of which displaying one of the previous templates. In Composite type, web reports and queries can be incorporated as components on the tabs.

The functional structure of web reports templates in the preferred embodiment of the present invention is as follows. Report templates are composed of two parts: The first is a set of metadata attributes exactly similar to web form templates. The second is a set of web Report Sections. Each web Report Section is composed of a mix of a set of Ditems and a set of Mobjects. Each set is designated by a ‘Date Delimiter’ attribute that defines the time span of search. The Ditem section contains several Ditems each specified by the special unique identifier of its Ditem Template. The Mobject section contains several Mobjects, each specified by the special unique identifier of its Mobject Template. The Mobject section sets the display mode the retrieved Mobjects set either as sequential individual ones, or compiles them to be displayed as a table. The column heads in this table are formed by the constituent Ditem Labels. The cells are filled with the constituent Ditem Values.

The elements of the web report are used to query the Production Database by the Reader module using the parameters defined in the report template. Returned Information is formatted to become End User-friendly when displayed by the Central or Render module. Access to web reports, is regulated in the Central module by certain attribute values of Mobject.

The functional structure of web Query Templates in the preferred embodiment of the present invention is as follows. Query templates are composed of two parts: The first part is a set of metadata attributes exactly similar to web form templates. The second part is the Query Definition part. In contrast to web Report Templates, the target of these query templates is not limited to the Production Database. The Query Definition part contains the URL address of the resource which is queried, and the parameters required to access the resource such as the password, username, and so forth, and finally the SQL statement representing the query.

Elements of a web query are used to query the Production Database by the Reader module using the parameters defined in the query template. Returned Information is formatted to become user-friendly when displayed by the Central or Render module. Access to web queries is regulated in the Central module by certain attribute values of Mobjects.

The functional structure of Process templates in the preferred embodiment of the present invention is as follows. Process templates are composed of two parts: The first is a set of metadata attributes exactly similar to web form templates. The second is the Process Definition part. The Process Definition part contains the Process Elements. The Process is composed of several templates of different types, such as web forms, web reports, and queries. The template specifies whether the elements are executed in a certain imperative sequence or randomly. Access to a Process Template is regulated in Central module by certain attribute values of the Process Template; furthermore, access to individual component templates of the Process is further controlled by specific access to that template.

Further attributes of the environment editor are as follows. The Environment Editor is a software module that makes part of the current invention's engine. In the digital definition of the Environment, several types of Things exist (Person, Organization, Device, Place, Project, etc) As such, a Thing is a further abstraction of an Entity. Each Thing can play one or more Role. For example: A Person (Thing) can play a

Role (Patient, or Doctor, or CEO) in the particular Environment. Roles are linked to each other by a self-reflecting relation table. In the Environment, a Menu Item is an Environment permission of the End User to execute a definite single action in the Environment; for example: Execute a Template (web Form, web Report, web query, or Process), or run a software function or an application. This action can be made very specific as to access a single Ditem Value in the Production Database.

Each Role is extended by an End User and each End User has a defined Environment privilege set that includes several Menu Items each of which can belong to one of several Menus.

The Environment Knowledge Base is a set of Environment tables that contains Environment specific definitions such as list of available services, and list of environment-specific technical terms such as list of name of anatomy parts in human body, list of named diseases, etc.

The functional role of the submitter module in the preferred embodiment of the present invention is as follows. The submitter receives End User-input and runtime values-updated templates and saves them in the Production Database.

The submitter is activated when the End User submits successfully; in other words, after a successful validation of his privileges to do so of a web form for saving.

The functional role of the reader module in the preferred embodiment of the present invention is as follows. The reader module has the credentials and data service key to be fully capable of accessing the Production Database and its constituents.

The reader module is responsible for retrieving information from the Production Database and returning it to the Render module. Returned information is formatted as computer-readable files that could be further processed by Render. Render can execute single table queries, joint queries, or search queries on the Production Database tables only.

The functional role of the render module in the preferred embodiment of the present invention is as follows. The render module displays web form templates as web forms, and implements the processing and business rules that are specified in the form template and its component Ditem Templates.

The render module processes the web form template to update component Ditems templates with End User-input and update web form template with runtime variables. Afterwards, Render sends the updated templates to the Submitter module that will save them in the Production Database.

The render module can also save certain data that is captured during runtime in other databases in addition to the Production Database. This functionality is executed when the template includes instruction to perform a ‘Parallel Insertion’. Parallel Insertion is a Render function that serves to update certain particular tables that are not part of Production Database. These tables serve a vertical functionality required in the business domain such as maintaining financial transactions that happen in the Environment. In this way, a web form that documents consumption of certain items from the stores of an organization can at the same time, by using Parallel Insertion, charge the account of the entity receiving the consumed items without creating and updating a special form for that purpose. Tables updated by Parallel Insertion are—as is the case of any other data resource—open to expose their content to query templates.

Render displays in End User-friendly format web pages or forms that are returned results from Reader.

The functional role of the central module in the preferred embodiment of the present invention is as follows:

The Central module interacts with Environment specific services to perform the functions of End User validation, Environment entity credentialing and privileging, and access to Environment Knowledge Base.

The Central module displays Menus in a sequence of that is affected by the attributes of Templates called by the End User during his interactions with the current invention modules. The display mode of a Menu is further affected by End User privileges regarding the member Menu Items of a Menu.

Functional integration between modules and external systems in the present invention is as follows. All messaging between the different modules of the current invention is executed through computer-readable files of XML or JSON markup languages. The engine of the present invention can integrate other software output if it is a computer-readable file that could be parsed by special plug in functions.

The engine can be integrated to send messages to other systems if recipient system is able to parse computer-readable files composed by special plug in functions.

In summary: the present invention is a software engine, that uses several software modules, to permit End Users, of any business domain, to design, create, and use unlimited number of different types of web forms and save their content in a fixed-structure database.

A first software module of the present invention is a Template Builder application that permits user to create computer-readable files thereafter called templates.

Templates are composed of XML/JSON text that, when processed, execute a definite computer function.

Templates can generate web controls, web forms, web reports, web queries, and web business processes; they include business rules defined by the user and enforced when the template is processed.

Templates set and control GUI appearance, menus and behavior, and render the GUI context-sensitive.

Templates set and persist information of sequence and relation between web forms whose contents have been saved in the Production Database; this permits retrieval of data input context.

Templates set and control the parameters and business rules of data-retrieval and data-filtration in the Production Database.

Templates can set seed values in web controls and web forms, saving the web form user from entering repeatedly used data.

The Structure of the Production Database does not change regardless of the number, type, and definition of feeding forms, business domain, or business rules; this fixed structure is nevertheless responsive to an unlimited number of different types of user-defined reports and queries.

A second software module of the present invention is a Render Module capable of processing Templates to display web forms and web reports. The Render captures user input in the displayed web forms. Render sends End User and runtime updated web form templates to be saved in Production Database by the Submitter module.

A third software module of the present invention is a Submitter Module that persists user input captured in web forms in the Production Database.

A fourth software module of the present invention is a Reader Module that retrieves information from Production Database in different user-defined formats.

The software engine of the present invention, in contrast to Object Oriented Programming OOP principles, is conceptually, methodically, and programmatically centered on data value and the metadata related to that value. The Objects, as known in OOP, do not exist in this software engine; the templates, are entirely built by the user without programming, and do not require any additional code writing in order to fulfill a complete functional lifecycle from template form design, to data capture, persistence, and retrieval.

To the knowledge of the Applicant, there is no described prior art that, within the frame of one single engine, achieves all of the above claims in a full functional lifecycle applicable in any business domain.

Although the invention has been explained in relation to its preferred embodiment, it is to be understood that many other possible modifications and variations can be made without departing from the spirit and scope of the invention as hereinafter claimed.

What is claimed is:

1. A method of operating a software engine for storing, organizing and reporting data in an organizational environment through user created templates and data items by executing computer-executable instructions stored on a non-transitory computer-readable medium comprises the steps of:
providing a template builder application;
providing a template database;
providing a production database;
(A) receiving user input through the template builder application in order to create a new data item (ditem) template, wherein the new ditem template comprises a plurality of ditem attributes, wherein the plurality of ditem attributes further comprises a plurality of user-assigned variables, a plurality of empty ditem runtime variables, a plurality of ditem processing instructions, and a plurality of ditem render attributes;
(B) storing the new ditem template in the template database;
(C) receiving user input through the template builder application in order to create a new metadata object (mobject) template, wherein the new mobject template comprises at least one ditem template, a plurality of empty mobject runtime variables, a plurality of mobject processing instructions, a plurality of mobject attributes, and a plurality of mobject render attributes;
(D) storing the new mobject template in the template database;
(E) receiving a request to retrieve a specific mobject template from the template database;
(F) retrieving the specific mobject template from the template database;
(G) assigning a plurality of mobject runtime values to the empty mobject runtime variables of the specific mobject template in order to create specified mobject runtime values for the specific mobject template;
(H) processing the specific mobject template according to the mobject render attributes of the specific mobject template in order to render the specific mobject template as a fillable form on a graphical user interface;
(I) displaying the fillable form on the graphical user interface;
(J) receiving at least one user input value through the graphical user interface, wherein each user input value is associated with a receiving ditem template of the specific mobject template;
(K) processing each user input value according to the ditem processing instructions of the receiving ditem template associated with each user input value;
(L) assigning each user input value to one of the receiving ditem templates of the specific mobject template in order to create at least one specified ditem;
(M) processing each specified ditem according to the mobject processing instructions of the specific mobject template;
(N) storing the specified mobject runtime values and the specified ditems in the production database as a first value-specified mobject;
(O) associating the specific mobject template, the specified mobject runtime values of the first value-specified mobject and each of the specified ditems with each other in the production database;
(P) repeating steps (D) through (O) in order to create a second value-specified mobject;
(Q) associating the first value-specified mobject with the second value-specified mobject with a mobject link in the production database,
if at least one of the mobject attributes of the second value-specified mobject is different from a corresponding mobject attribute value of the first value-specified mobject, and
if the second value-specified mobject is created directly after the first value-specified mobject is rendered or created.

2. The method of operating a software engine for storing, organizing and reporting data in an organizational environment through user created templates and data items by executing computer-executable instructions stored on a non-transitory computer-readable medium as claimed in claim 1 comprises the steps of:
receiving a data report request, wherein the data report request comprises at least one data range attribute;
searching the production database for at least one ditem result, wherein each ditem result corresponds to one of the data range attributes; and
displaying each of the ditem results on the graphical user interface.

3. The method of operating a software engine for storing, organizing and reporting data in an organizational environment through user created templates and data items by executing computer-executable instructions stored on a non-transitory computer-readable medium as claimed in claim 1 comprises the steps of:
providing that the plurality of ditem processing instructions include at least one business rule;
comparing each user input value to the business rules in order to determine if the user input values are valid for the receiving ditem templates; and
assigning each user input value to one of the receiving ditem templates of the specific mobject template in order to create at least one specified ditem, if the user input values are valid for the receiving ditem templates.

4. The method of operating a software engine for storing, organizing and reporting data in an organizational environment through user created templates and data items by executing computer-executable instructions stored on a non-transitory computer-readable medium as claimed in claim 3 comprises the steps of:
providing that at least one of the receiving ditem templates comprises a computer-executable instruction; and
executing the computer-executable instruction, if the user input value is valid for the receiving ditem template.

5. The method of operating a software engine for storing, organizing and reporting data in an organizational environment through user created templates and data items by executing computer-executable instructions stored on a non-transitory computer-readable medium as claimed in claim 3 comprises the steps of:
providing that at least one of the receiving ditem templates comprises a computer-readable instruction; and
executing the computer-readable instruction, if the user input value is valid for the receiving ditem template.

6. The method of operating a software engine for storing, organizing and reporting data in an organizational environment through user created templates and data items by executing computer-executable instructions stored on a non-transitory computer-readable medium as claimed in claim 1 comprises the steps of:
providing that the plurality of mobject processing instructions include at least one business rule;
comparing each specified ditem to the business rules in order to determine if the specified ditems are valid for the specific mobject template; and
storing the specified mobject runtime values and the specified ditems in the production database, if the specified ditems are valid for the specific mobject template.

7. The method of operating a software engine for storing, organizing and reporting data in an organizational environment through user created templates and data items by executing computer-executable instructions stored on a non-transitory computer-readable medium as claimed in claim 6 comprises the steps of:
providing that the specific mobject template comprises a computer-executable instruction; and
executing the computer-executable instruction, if the specified ditems are valid for the specific mobject template.

8. The method of operating a software engine for storing, organizing and reporting data in an organizational environment through user created templates and data items by executing computer-executable instructions stored on a non-transitory computer-readable medium as claimed in claim 6 comprises the steps of:
providing that the specific mobject template comprises a computer-readable instruction; and
executing the computer-readable instruction, if the specified ditems are valid for the specific mobject template.

9. The method of operating a software engine for storing, organizing and reporting data in an organizational environment through user created templates and data items by executing computer-executable instructions stored on a non-transitory computer-readable medium as claimed in claim 1 comprises the steps of:
providing that the fillable form comprises a plurality of web controls; and
receiving the user input values through the plurality of web controls.

10. The method of operating a software engine for storing, organizing and reporting data in an organizational environment through user created templates and data items by executing computer-executable instructions stored on a non-transitory computer-readable medium as claimed in claim 1 comprises the steps of:
providing an environment editor application; and
receiving user input through the environment editor application to define a digital environment, wherein the digital environment comprises end user permissions.

11. The method of operating a software engine for storing, organizing and reporting data in an organizational environment through user created templates and data items by executing computer-executable instructions stored on a non-transitory computer-readable medium as claimed in claim 10 comprises the steps of:
providing that the specific mobject template is requested for retrieval by a specific end user identifier;
comparing the specific end user identifier to the user permissions in order to determine if the specific end user identifier is permitted to access the specific mobject template; and
retrieving the specific mobject template, if the specific end user identifier is permitted to access the specific mobject template according to the user permissions.

12. The method of operating a software engine for storing, organizing and reporting data in an organizational environment through user created templates and data items by executing computer-executable instructions stored on a non-transitory computer-readable medium as claimed in claim 10 comprises the steps of:
receiving a request from a specific end user identifier to retrieve a value-specified mobject from the production database;
receiving user input from the specific end user identifier to modify one of the specified ditems of the value-specified mobject;
comparing the specific user identifier to the user permissions in order to determine if the specific end user identifier is permitted to modify the specified ditem; and
modifying the specified ditem according to the user input, if the specific end user identifier is permitted to modify the specified ditem.

13. The method of operating a software engine for storing, organizing and reporting data in an organizational environment through user created templates and data items by executing computer-executable instructions stored on a non-transitory computer-readable medium as claimed in claim 1 comprises the steps of:
providing a render module;
processing the specific mobject template through the render module according to the mobject render attributes of the specific mobject template in order to render the specific mobject template as the fillable form on the graphical user interface;
receiving the user input values through the render module; and
processing the fillable form with the user input values through the render module in order to update the ditem templates of the fillable form with the user input values.

14. The method of operating a software engine for storing, organizing and reporting data in an organizational environment through user created templates and data items by executing computer-executable instructions stored on a non-transitory computer-readable medium as claimed in claim 13 comprises the step of:
sending the specific mobject runtime values and the specified ditems of the first value-specified mobject to a submitter module for submission to the production database;

15. The method of operating a software engine for storing, organizing and reporting data in an organizational environment through user created templates and data items by executing computer-executable instructions stored on a non-transitory computer-readable medium as claimed in claim 1 comprises the steps of:
providing a submitter module;
receiving the specific mobject runtime values and the specified ditems of the first value-specified mobject from a render module through the submitter module; and
storing the specific mobject runtime values and the specified ditems of the first value-specified mobject in the production database through the submitter module.

16. The method of operating a software engine for storing, organizing and reporting data in an organizational environment through user created templates and data items by executing computer-executable instructions stored on a non-transitory computer-readable medium as claimed in claim 1 comprises the steps of:
providing a central module; and
creating the plurality of mobject runtime values and the plurality of ditem runtime values through the central module.

17. The method of operating a software engine for storing, organizing and reporting data in an organizational environment through user created templates and data items by executing computer-executable instructions stored on a non-transitory computer-readable medium as claimed in claim 1 comprises the steps of:
providing a reader module;
receiving the request to retrieve the specific mobject template from the template database through the reader module; and
retrieving the specific mobject template from the template database through the reader module.

18. The method of operating a software engine for storing, organizing and reporting data in an organizational environment through user created templates and data items by executing computer-executable instructions stored on a non-transitory computer-readable medium as claimed in claim 17 comprises the step of:
sending the specific mobject template to the render module from the reader module.

19. The method of operating a software engine for storing, organizing and reporting data in an organizational environment through user created templates and data items by executing computer-executable instructions stored on a non-transitory computer-readable medium as claimed in claim 17 comprises the step of:
sending the specific mobject template to the central module from the reader module.

20. The method of operating a software engine for storing, organizing and reporting data in an organizational environment through user created templates and data items by executing computer-executable instructions stored on a non-transitory computer-readable medium as claimed in claim 1 comprises the steps of:
providing a peripheral database;
providing at least one peripheral ditem rule;
comparing the specified ditems to the peripheral ditem rules in order to identify at least one parallel insertion value; and
storing the parallel insertion value in the peripheral database, if the parallel insertion value is found.
